(19) United States
(12) Patent Application Publication
(10) Pub. No.: US 2004/0153386 A1
(43) Pub. Date: Aug. 5, 2004

(54) Tangible security asset management system and methods thereof

(76) Inventor: George Eckerdt, Fishers, NY (US)

Correspondence Address: Nixon Peabody LLP, Clinton Square, P.O. Box 31051, Rochester, NY, 14603-1051, US

(21) Appl. No.: 10/644,383

(22) Filed: Aug. 19, 2003

Related U.S. Application Data
(60) Provisional application No. 60/404,158, filed on Aug. 19, 2002.

(51) Int. Cl. G06F 17/60

(52) U.S. Cl. 705/36; 705/1; 705/26

(57) ABSTRACT

An asset management system and methods for managing assets are disclosed. The asset management system includes one or more security asset managers (“SAMs”). Each SAM includes one or more stations where each of the stations receive an asset to be stored, such as a key. Further, each of the SAMs include a web server. The web server in each SAM provides each SAM with direct access to a network as well as processing capabilities. The web server determines whether each one of the SAMs should permit tangible assets to be removed from or replaced to the stations in the SAM. Further, the web server in each SAM stores data regarding transactions involving the stations, and provides this information to authorized users at remote systems. The web server also enables the remote systems to configure the web server, such as for setting up new user accounts or setting alarm conditions, as well as for directly controlling the SAMs.

This application claims the benefit of U.S. Provisional Patent Application Serial No. 60/404,158 filed on Aug. 19, 2002, which is herein incorporated by reference.

### FIELD OF THE INVENTION

This invention relates generally to electronic devices that monitor the placement or removal of articles in or coupled to the device and, more particularly, to one or more asset control systems incorporating a Web server that provides remote devices with real-time access to asset monitoring information.

### BACKGROUND OF THE INVENTION

Employees, customers and others associated with organizations, such as a prisons, casinos, vehicle fleet operators, schools ambulance companies or governmental agencies and many others, often need to use a variety of the organization's tangible assets, such as specialized tools, knives, medicine, or keys to buildings, vehicles and file cabinets. It is in these organizations' best interest to monitor the use of these assets to limit potential losses and liability. For instance, absolute control must be maintained over medicine kept in an ambulance to ensure that drug safety and use regulations are being complied with. Monitoring the use of assets requires knowing who has which asset, when the asset was taken (or returned), as well as other information. Traditional means for storing assets, such as keeping keys on a string or keeping knives in a box, do not provide the necessary control over these assets.

The above-noted issues are being partially dealt with by electronically based systems, such as systems used to manage keys. Referring to FIG. 1, an exemplary system 10 that includes a plurality of key control units 12 is shown. Each of the key control units 12 comprises a key access control system 14 that can monitor the use of a set of keys corresponding to assigned key bays (not illustrated) in each of the systems 14. Further, each of the key access control systems 14 is coupled to a PC management system 18 via an I/O 16. For instance, a user may checkout a key from a bay in one of the key control units 12 by inputting a pin code into a keypad controller unit on the key control unit 12 (not illustrated). The keypad controller unit then checks its records for determining whether to permit or refuse access to the key based on the inputted pin code. Additionally, the PC management system 18 polls the key control units 12 from time to time or when requested by a user to download transaction records and to deliver programming updates (e.g., add/delete user accounts) to the units 12.

This exemplary system 10 works, but the I/O 16 in each key control unit 12 is limited in the types of systems it can communicate with and the types of functions it can perform. Connecting each of the key control units 12 to the PC management system 18 involves complicated hardware connections. Providing remote devices with access to each of the key control units 12 using the PC management system 18 would also involve complicated hardware connections. Once the system 10 is in place, upgrading one of the key control units 12 requires upgrading all of the units 12 resulting in the expenditure of a significant amount of labor. Another disadvantage is that if the PC management system 18 becomes inaccessible then none of the key control units 12 can be accessed, polled or updated. Also, requiring the PC management system 18 to poll the key control units 12 for delivering programming updates or downloading transaction records is disadvantageous for several reasons. The PC management system 18 may not always have the most current transaction information since the system 18 must poll the key control units 12 each time to obtain the information. Likewise, the key control units 12 may not always have the most current programming. Additionally, having one point of contact and processing at the management system 18 further limits the types of functions and features of the system 10.

### SUMMARY OF THE INVENTION

An asset management system in accordance with an embodiment of the present invention includes one or more stations for receiving a tangible asset and a server system coupled to a communication medium. The server system stores information regarding tangible asset transactions between the stations and the tangible assets in the asset management system and allows the asset management system to be accessed remotely via the communication medium.

A method and a program storage device readable by a machine and tangibly embodying a program of instructions executable by the machine for managing assets in accordance with other embodiments of the present invention include providing an asset management system with one or more stations for receiving a tangible asset and a server system coupled to a communication medium, storing information regarding tangible asset transactions between the stations and the tangible assets, and allowing the asset management system to be accessed remotely via the communication medium.

The present invention provides a number of advantages. By providing each one of the security asset managers with a web server, each of the security asset managers can be accessed directly by remote devices on a network. The remote systems are able to obtain current transaction records from the security asset managers, provide the security asset managers with programming updates and actually control the security asset managers. Since the security asset managers do not need to rely on any intermediate systems, the present invention offers a simpler way to interconnect the security asset managers which uses less power overall. This results in a more robust system since the security asset managers can function independently as a result of not having to rely on the intermediate systems. Further, remote systems can more easily access the security asset managers directly resulting in enhanced system performance. Each security asset manager can be modified, upgraded and/or replaced without affecting any of the other security asset managers that are not being changed. Additionally, the system can continue to operate despite one or more of the security asset managers becoming inaccessible.

### BRIEF DESCRIPTION OF THE DRAWINGS

FIG. 1 is a diagram of an exemplary system for managing keys;

FIG. 2 is a diagram of an asset management system in accordance with an embodiment of the present invention;

FIGS. 3, 5, 7, 11, 12 and 14 are flow charts of portions of the process for managing assets in accordance with embodiments of the present invention; and

FIGS. 4, 6, 8-10, 13 and 15 are screen prints of graphical user interfaces used in accordance with embodiments of the present invention.

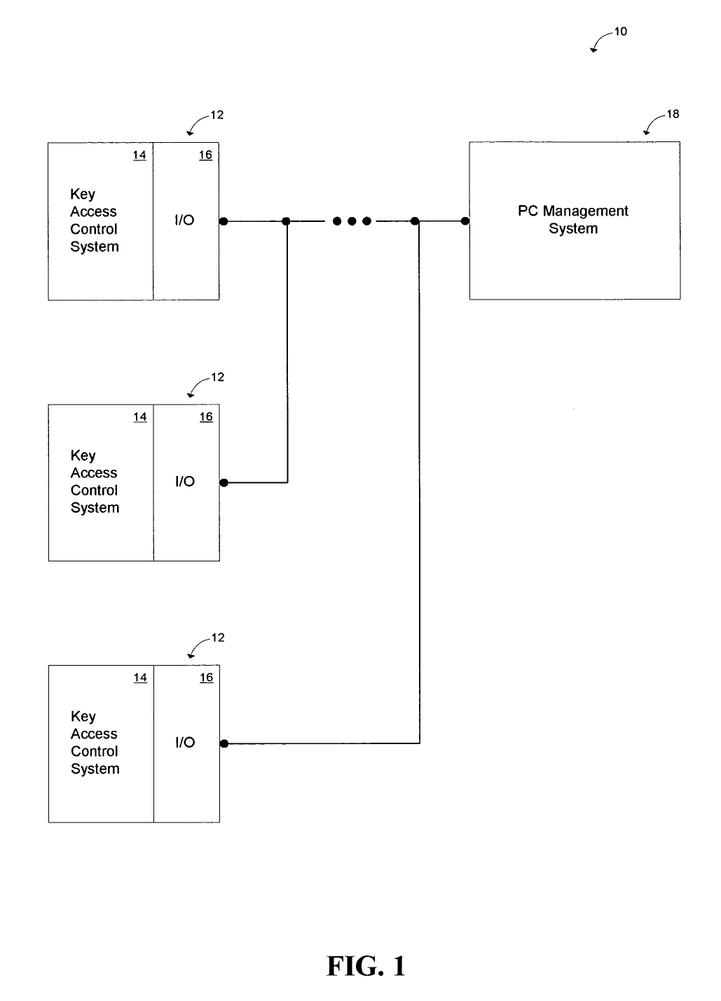

### DETAILED DESCRIPTION OF THE INVENTION

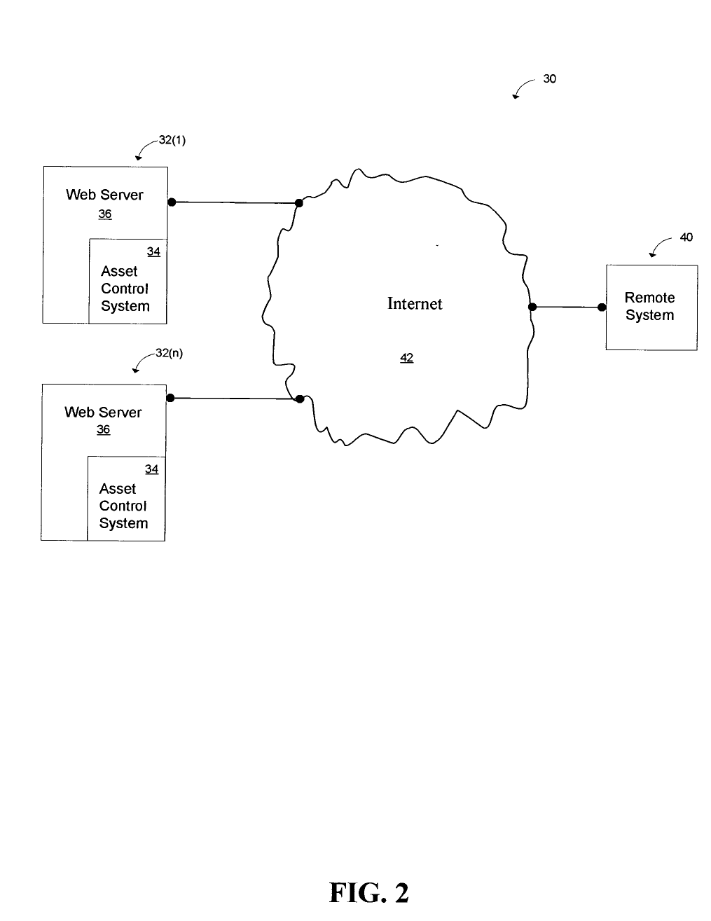

An asset management system 30 and methods for managing assets in accordance with embodiments of the present invention are shown in FIGS. 2, 3, 5, 7, 11 and 12. In one embodiment of the present invention, the asset management system 30 includes one or more security asset managers 32(1)-32(n) each having an asset control system 34 and a web server 36, where each of the security asset managers 32(1)-32(n) is coupled directly to a remote system 40 via Internet 42, although other types of communication networks could be used. The asset management system 30 enables the remote system 40 to communicate directly with each of the security asset managers 32(1)-32(n) to ensure the remote system 40 receives current transaction information, ensure the managers 21 are able to receive current software upgrades, and to allow the remote system 40 to control the security asset managers 32(1)-32(n) resulting in a simpler system 30 which uses less power and has greater overall performance.

Each of the security asset managers 32(1)-32(n) comprises an asset control system 34 and a web server 36, which are arranged within an enclosure (not illustrated) with an access door (not illustrated), although the security asset managers 32(1)-32(n) may comprise other components in other arrangements. Each of the security asset managers 32(1)-32(n) also includes a keypad user input interface (not illustrated) arranged on an exterior surface of the enclosure, an audio device (not illustrated) for generating sounds such as alarm signals, mechanisms (not illustrated) and sensors (not illustrated) for controlling the access door and stations in the security asset manager 32(1) and detecting when the doors are opened or closed and when an asset is present in the stations, although other types of input devices may be used (e.g., card readers, access card readers, bar code scanners, proximity card readers, biometric reader devices), the input interface may be arranged in other locations and other types of devices may be used to generate alarm signals. The enclosure and access door are both made of stainless steel panels, although the enclosure may be made out of other suitable materials. The enclosure and access door ensure that the components of each of the security asset managers 32(1)-32(n) are secure from unauthorized users. Further, the asset control system 34, web server 36, keypad user input interface, access door, audio device, mechanisms, and sensors are coupled together by one or more bus systems or other communication links (not illustrated).

The asset control system 34 includes one or more stations (not illustrated) where tangible assets, such as medicine, tools, knives, and keys, for example, may be received or released there from, although other means may be used instead of stations to receive and release assets, such as protrusions (e.g., hooks).

The web server 36 comprises an eZ80™ Webserver microprocessor with onboard memory and an I/O unit manufactured by Zilog, Inc., although other types of web servers can be used. The web server 36 uses about 40 mA of power at about 40 MHz. Thus, the web server 36 uses little power yet is powerful in terms of processing speed. The web server 36 executes at least a portion of programmed instructions stored in the memory for managing assets as described and illustrated herein, although the web server 36 may comprise circuitry hardwired to perform these functions, such as an ASIC chip. The memory comprises any type of fixed or portable memory accessible by the web server 36, such as ROM, RAM, SRAM, DRAM, DDRAM, hard and floppy-disks, CDs, DVDs, magnetic tape, optical disk, ferroelectric and ferromagnetic memory, electrically erasable programmable read only memory, flash memory, charge coupled devices, smart cards, or any other type of computer-readable media. The memory stores the programmed instructions as well as other information, although the instructions may be stored elsewhere. The I/O unit couples the web server 36 to the Internet 42 and comprises an Ethernet interface, although other types of interfaces may be used including RS232, RS485, and wireless communication interfaces.

The remote system 40 comprises a desktop personal computer with a processor, memory, user input devices (e.g., mouse and keyboard), output devices (e.g., monitor and/or printer) and an I/O unit, which are coupled together by one or more bus systems or other communication links (not illustrated), although the system 40 may comprise other types of computers and systems including cellular telephones, PDA devices, and laptop computers. Although just one remote system 40 is illustrated, it should be appreciated that one or more remote systems will typically be used. The processor executes at least a portion of programmed instructions stored in the memory of the remote system 40 for managing assets as described and illustrated herein, although the processor may comprise circuitry hardwired to perform these functions, such as an ASIC chip. The memory in the remote system 40 comprises the same type of memory used in the security asset managers 32(1)-32(n), although other types of memory may be used. The memory stores the programmed instructions as well as other information, although the instructions may be stored elsewhere. Further, the I/O unit provides the system 40 with access to the Internet 42 and comprises the same type of I/O unit used in the web server 36, although other types of I/O units may be used.

The Internet 42 enables the security asset managers 32(1)-32(n) and the remote system 40 to communicate with each other, although other communication mediums could be used. In embodiments of the present invention, the Internet 42 comprises a TCP/IP network, such as the World Wide Web, although other types of line-based networks may be used, such as Intranets (e.g., LANs, WANs) using telephone line and/or coaxial cable, ISDN networks, as well as wireless networks (e.g., satellite, IR, radio), and combinations thereof.

A portion of the operation of the asset management system 30 in accordance with an embodiment of the present invention will now be described with reference to FIGS. 2-4. By way of example only, a user, such as an administrator, at the remote system 40, may desire adding a new user account to be stored in the memory of the web server 36 in one of the security asset managers 32(1)-32(n), such as the manager 32(1), although the user account information may be stored elsewhere, the new user account may be added directly in the memory of the web server 36 using the keypad interface on the manager 32(1), and new user account may be added for one or more security asset managers 32(1)-32(n) rather than just the manager 32(1). This new user account will allow the user associated with the new account to access the security asset manager 32(1).

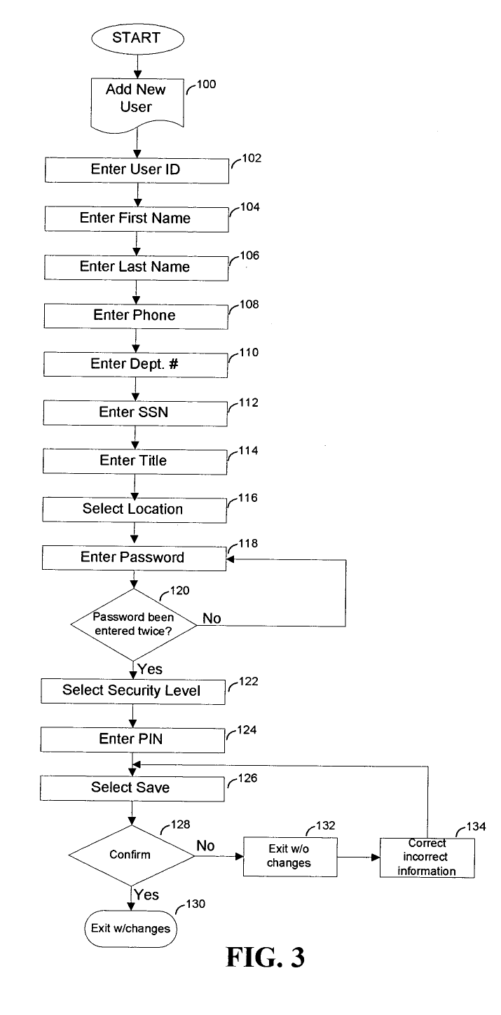

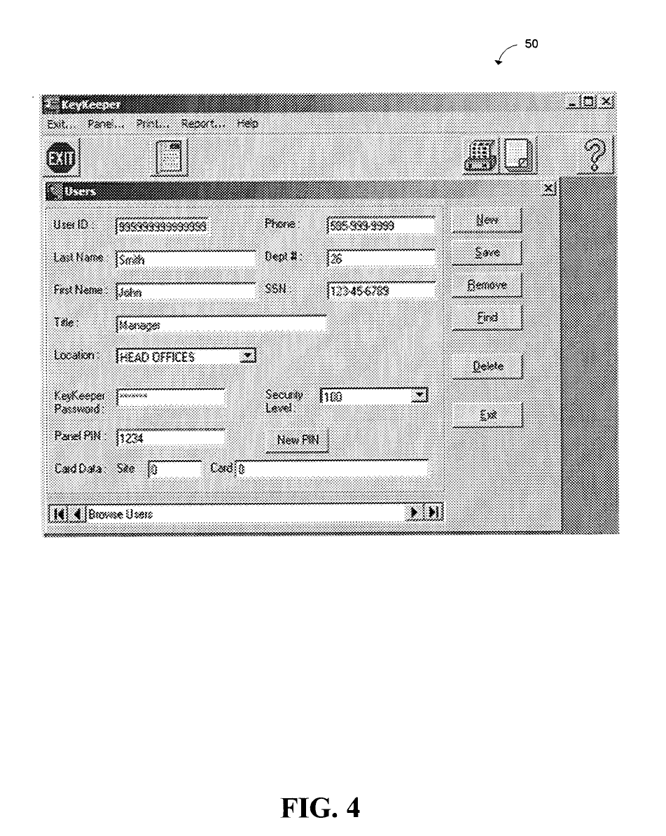

Accordingly and referring to FIG. 3, at step 100, a process begins to add the account information for a new user. Thus, the administrator on the remote system 40 accesses a first Web page (not illustrated) stored in the memory of the web server 36 in security asset manager 32(1). The remote system 40 is able to find the asset manager 32(1) on the Internet 42 by locating the IP address of the web server 36, for example. The remote system 40 displays the web page (not illustrated) received from the security asset manager 32(1), and the web server 36 requests a user ID and a password from the administrator before access to additional pages stored in the web server 36 is granted. If the administrator inputs a correct user ID and password, the web server 36 sends a second web page (not illustrated) presenting the user with various options, such as adding a new user account to the web server 36, for example. The user selects the appropriate icons (or other triggers) on the Web page using the input devices of the remote system 40 to indicate their desire to add information for creating a new user account. In response, the web server 36 sends a new user page 50 to the remote system 40 for the administrator to be able to input data through as shown in FIG. 4.

At steps 102-108, the administrator inputs the new user's user ID, first name, last name and telephone number, respectively. At steps 110-116, the administrator inputs the new user's department number, title and the new user's department location, respectively. The web server 36 may present the administrator at remote system 40 with an additional page (not illustrated) for inputting data to describe the security asset manager 32(1) that the new user will have access to in this example. This location information may include the name and description of the location, such as the address, city, state and zip code of the location (e.g., building).

At step 118, the administrator at the remote system 40 inputs a password for the new user that the new user can use to access the web server 36, and hence the security asset manager 32(1) in this example. At decision box 120, the web server 36 prompts the administrator to input the new user's password a second time. If the administrator has not inputted the password a second time or the password inputted the second time was incorrect, then the NO branch is followed and steps 118-120 are repeated until the administrator inputs the same password twice for the new user. When the web server 36 determines at decision box 120 that the user has inputted the same password twice, the YES branch is followed.

At step 122, the administrator at the remote system 40 may select one or more security levels for the new user. For example, as shown in FIG. 4, a security level of 100 is being selected. A security level of 100 may allow full use of the web server 36 and/or web server 36. At step 124, the administrator may input a personal identification number (“PIN”) code that is assigned to the new user so that the user can access the security asset manager 32(1). At step 126, the administrator may select the “save” button in the new user page 50 shown in FIG. 4 to save all the data input at steps 100-124 as described above.

At decision box 128, the web server 36 prompts the administrator to confirm whether the data input above at steps 100-124 is correct. If the administrator does not confirm that the data is correct, the NO branch is followed. At step 132, the web server 36 does not save the data input above at steps 100-124. At step 134, the user is prompted to correct any input data that is incorrect, and steps 126-134 are repeated until the administrator confirms at decision box 128 that the data input above at steps 102-124 is correct. Once the administrator confirms at decision box 128 that the data is correct, the YES branch is followed. At step 130, the web server 36 stores the data inputted at steps 100-124 in a database, such as an MS Access database, in the memory of the web server 36 and the process ends.

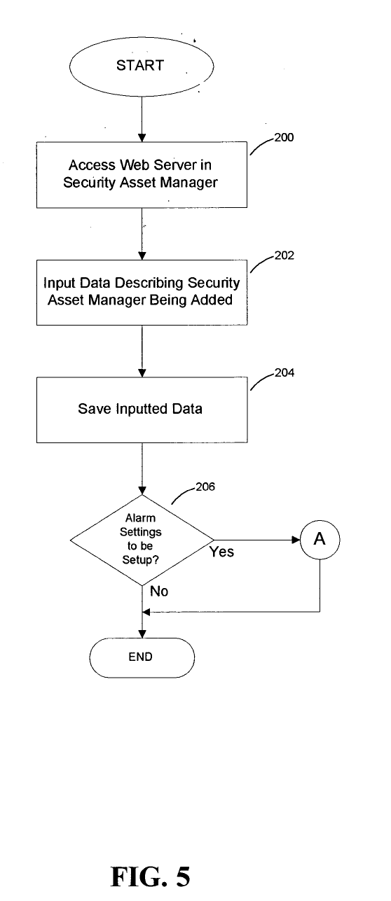

Another portion of the operation of the asset management system 30 in accordance with another embodiment of the present invention will now be described with reference to FIGS. 5-10. By way of example only, the administrator of the remote system 40 may desire adding a new security asset manager, such as security asset manager 32(1), to the asset management system 30.

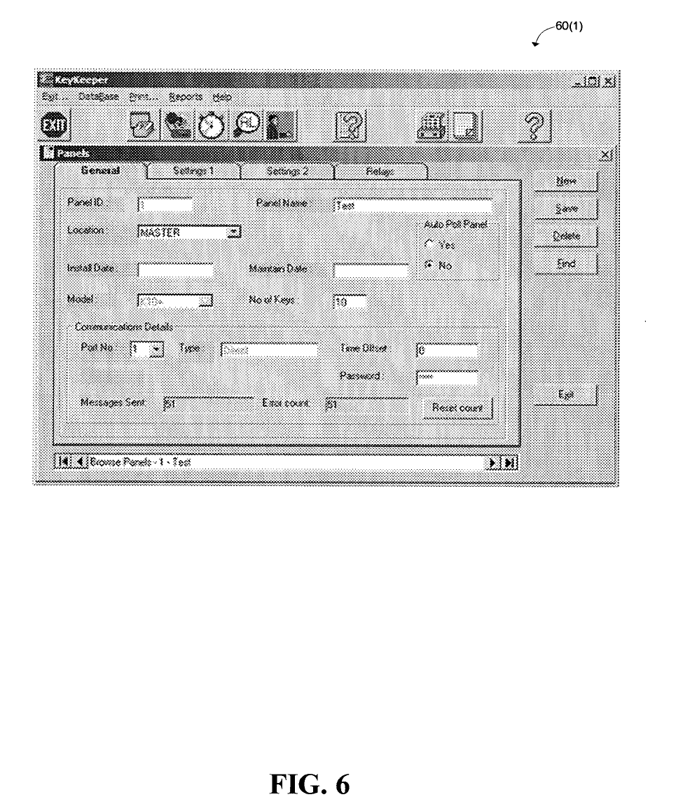

Accordingly, and referring to FIG. 5, a process begins to add security asset manager 32(1) to the asset management system 30. Initially, the security asset manager 32(1) is physically coupled to the Internet 42 and the web server in the security asset manager 32(1) is assigned an IP address. At step 200, the administrator at the remote system 40 accesses the web server 36 to receive a first Web page stored in the server 36 as described above in connection with step 100. The user selects the appropriate icons or other triggers in the page to initiate adding the security asset manager 32(1) to the asset management system 30. In response, the web server 36 sends a new security asset manager page 60(1) to the remote system 40 for the administrator to be able to input data as shown in FIG. 6. The new security asset manager page 60(1) provides fields that enable the administrator to input data describing the new security asset manager 32(1) being added to the asset management system 30.

At step 202, the administrator at the remote system 40 inputs data describing the security asset manager 32(1) being added to the asset management system 30. In particular, the administrator inputs a panel ID representing the unique identification number of the security asset manager being added, a panel name representing a name assigned to the security asset manager, the location of the security asset manager, the installation date of the security asset manager, and many assets, such as keys, the security asset manager being added will hold, although the page 60(1) can be used to input other information.

At step 204, the administrator selects a save button in the new security asset manager page 60(1) to cause the web server 36 to save the data inputted at steps 200-204 as described above.

At decision box 206, if the administrator does not desire configuring any alarm systems for the security asset manager 32(1) being added to the asset management system 30, then this portion of the process ends. However, if the administrator desires configuring alarm settings for the asset control system, then the YES branch is followed and steps 210-214 are performed as described herein.

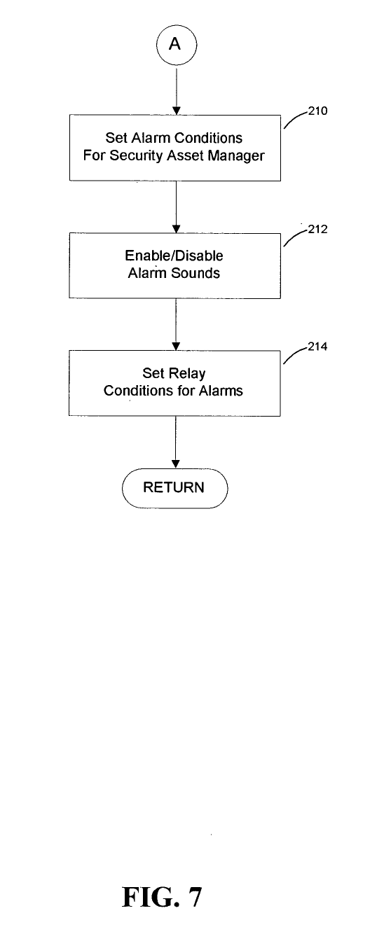

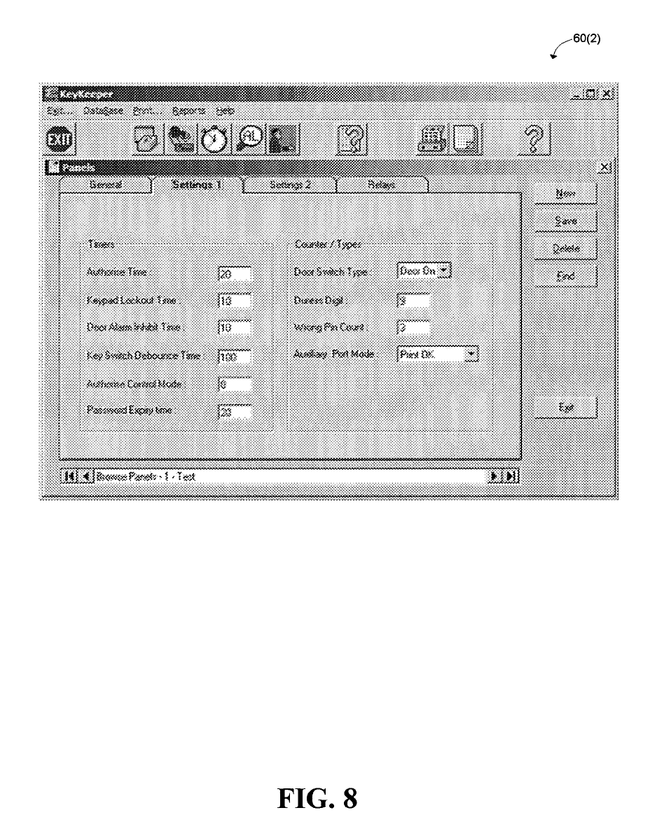

Referring to FIGS. 7-8, at step 210 the user selects the tab identified as “Settings 1” in the new security asset manager page 60(1). In response, the web server 36 refreshes the new asset manager page 60(1) and creates new security asset manager page 60(2) to present the “Settings 1” folder as shown in FIG. 8. Here, the administrator may input data to configure the web server 36 so that an alarm is sounded upon a number of conditions being met. For instance, the administrator may input ‘Authorize Time’ data representing the number of seconds the access door of the security asset manager 32(1) may stay open after a user has successfully inputted a PIN code before an alarm will sound. Additionally, the administrator may input ‘Wrong PIN Count’ data representing the number of incorrect PIN codes the user may input into the keypad interface of the security asset manager 32(1) before the alarm is sounded.

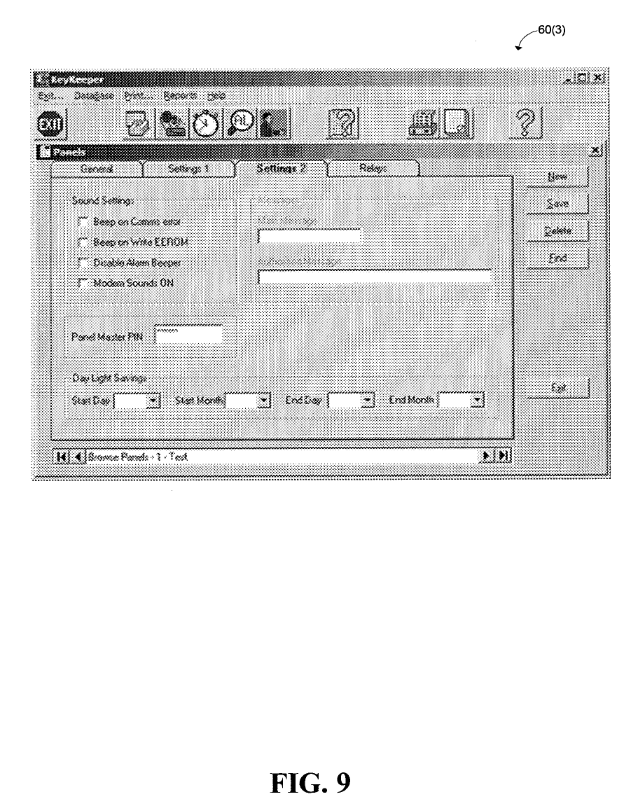

Referring to FIG. 9, at step 212, the administrator optionally selects the “Settings 2” tab in the new security asset manager page 60(2), and in response the web server 36 refreshes the page 60(2) and creates page 60(3) to present the “Settings 2” folder. Here, the administrator may input data by selecting on or more checkboxes to configure the web server 36 with respect to enabling the alarm to be heard at one or more locations, such as at or one or more of the security asset managers 32(1)-32(n) and/or the remote system 40.

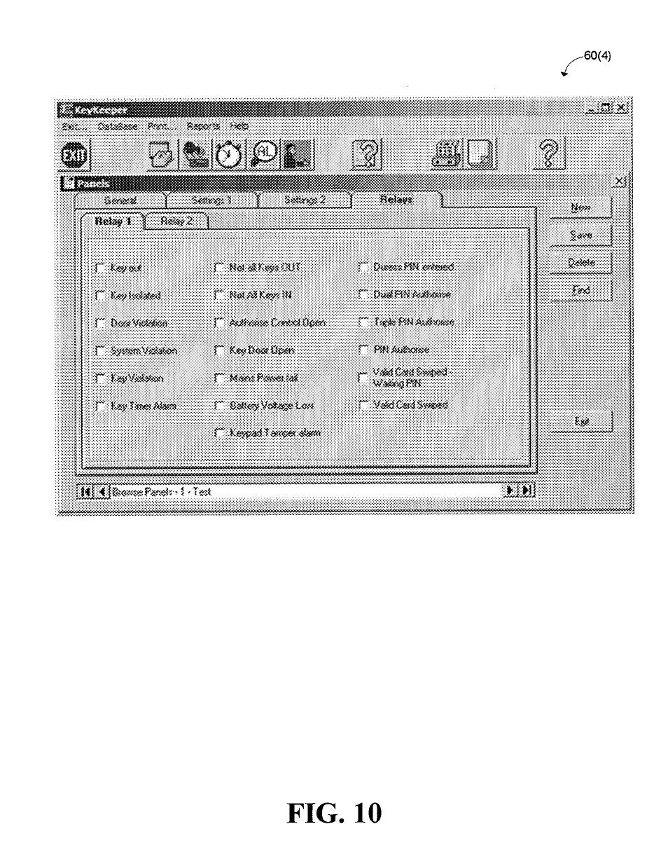

Referring to FIG. 10, at step 214, the administrator optionally selects the “Relays” tab in the new security asset manager page 60(3). In response, the web server 36 refreshes the page 60(3) and creates the page 60(4) to present the “Relays” folder. Here, the administrator may input data by selecting one or more checkboxes to indicate particular conditions that will trigger the alarm. For example, checking the “Key Out” checkbox will cause an alarm to be sounded whenever an asset, such as a key, is removed from the security asset manager 32(1) being added to the asset management system 30. Another example includes an administrator selecting the “Key Door Open” checkbox to configure the web server 36 to sound an alarm whenever the access door of the security asset manager 32(1) being added to the asset management system 30 is opened. As shown in the new security asset manager page 60(4), additional conditions may be set to trigger the alarm.

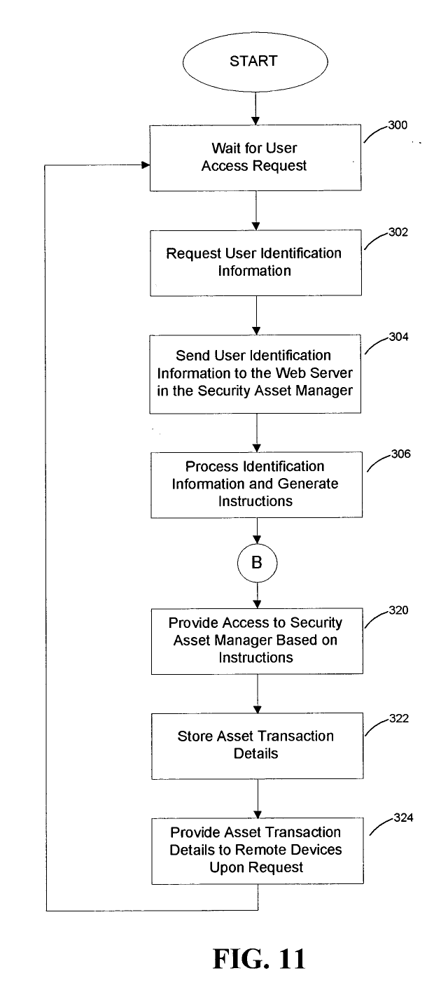

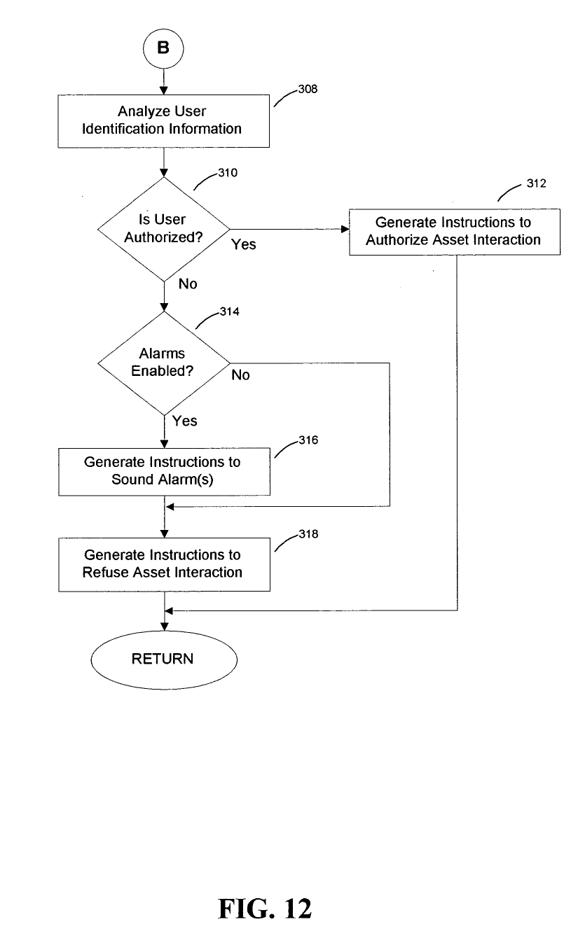

Another portion of the operation of the asset management system 30 in accordance with another embodiment of the present invention will now be described with reference to FIGS. 11-12. By way of example only, one or more users may desire taking (or replacing) one or more assets stored or being monitored by one of the security asset managers 32(1)-32(n). Beginning at step 300, each of the security asset managers 32(1)-32(n) await access requests from users. In particular, each of the security asset managers 32(1)-32(n) polls the respective keypad interface coupled to each of the security asset managers to determine whether any of the keys are being are being pressed, for example.

At step 302, the asset control system 34 in one of the security asset managers 32(1)-32(n), such as security asset manager 32(1), detects that one of the keys has been pressed and requests the user to input a user ID and a PIN code at the keypad interface, although the user may input the data using an access control card or other means depending on the user input interface coupled to the security asset manager 32(1).

At step 304, the keypad interface in the security asset manager 32(1) sends the user identification information (i.e., user ID and PIN code) to the web server 36 along with a request for instructions with respect to permitting or refusing the user to access the access door of the security asset manager 32(1).

At step 306, the web server 36 processes the identification information to generate instructions for the security asset manager 32(1).

Referring to FIG. 12, at step 308, the web server 36 receives the user identification information. At decision box 310, the web server 36 determines whether the user, as identified by the user identification information (i.e., user ID and PIN code) is authorized to access the security asset manager 32(1). The web server 36 examines a database, such as an MS Access database, in the memory of the web server 36 to determine whether the user ID included in the user identification information is present. If the user ID is present, the web server 36 examines the PIN code associated with the user ID in the database to compare it with the PIN code included in the user identification information sent to the web server 36 at step 304. If the PIN code in the user identification information matches the PIN code associated with the user ID in the database, then the web server 36 determines that the user is authorized and the YES branch is followed. At step 312, the web server 36 generates instructions to authorize the user to access the asset control system 32(1).

If at decision box 310 the web server 36 determines that the user is not authorized because the PIN code in the user identification information does not match the PIN code associated with the user ID in the database or the user ID is not present in the database, then the NO branch is followed.

At decision box 314, the web server 36 examines another database in the memory of the web server 36 to determine whether the alarm was set at steps 210-214 for the security asset manager 32(1). If the web server 36 determines that the alarm was not set, then the NO branch is followed. If the web server 36 determines that the alarm was set, then the YES branch is followed.

At step 316, the web server 36 generates instructions to cause the security asset manager 32(1) and/or the remote system 40 to sound an alarm according to the alarm settings input by the administrator at the remote system 40 at steps 210-214.

At step 318, the web server 36 generates instructions to cause the security asset manager 32(1) to refuse access to the user with regard to opening the access door of the security asset manager 32(1).

Referring back to FIG. 11, at step 320, the web server 36 in the security asset manager 32(1) refuses to allow the access door for the security asset manager 32(1) to be opened or opens the access door according to the instructions received. If the instructions instruct the security asset manager 32(1) to open the access door, then the web server 36 causes a mechanism (not illustrated) in the security asset manager 32(1) to open the door and the user may remove one or more assets from their stations and/or the user may replace one or more assets to their stations in the security asset manager 32(1) depending on the user's access level as described above in connection with step 122. For example, the user may be authorized to access a first number or a particular set of stations only, and thus the web server 36 will only allow the user to access the stations according to the access level.

It should be noted that the web server 36 monitors the status of the stations in the security asset manager 32(1), such as which assets are being removed from or replaced to the stations, although other information may be monitored, such as a temperature of the assets in the stations, the presence of assets in the stations, and the weight of the assets in the stations. The web server 36 also stores additional transaction details in the memory with regard to the particular station involved in the transaction, such as whether the station(s) received assets and whether assets were taken from the stations(s).

Further, the security asset manager 32(1) enforces rules associated with the user ID as provided for in the received instructions, and sound the alarm when the alarm conditions input at steps 210-214 have occurred. For example, the user associated with the particular user ID may only be allowed to remove (or replace) assets to particular stations, at particular, times, or on particular dates, for example. The web server 36 also monitors the access door of the security asset manager 32(1) to determine whether any alarm conditions with respect to the amount of time the door is opened have occurred, although other information may be monitored. If the web server 36 determines that the alarm conditions have been met, then the web server 36 instructs the security asset manager 32(1) and/or the remote system 40 to sound an alarm. The user completes the asset transaction by taking or replacing an asset as described above and closing the access door.

At step 322, the web server 36 stores details describing the asset transaction, such as user identification information, information describing the circumstances of the user access attempt (i.e., refused or allowed), the date and/or time of the transaction, identity of the security asset manager 32(1), and the instructions which were generated, in yet another database in the memory of the web server 36.

At step 324, the web server 36 in the security asset manager 32(1) provides the stored asset transaction information to the remote system 40 upon request. The asset transaction information may be retrieved as desired by authorized users at remote system 40 to be displayed by the display device of the remote system 40 and/or printed using a printing device, for example. Since the web server 36 is in constant communication with the security asset manager 32(1), the remote system 40 is able to receive the most current asset transaction details from the security asset manager 32(1). The security asset manager 32(1) performs steps 300-324 as described above until the security asset manager 32(1) is no longer powered or operation is interrupted in another manner and the process ends.

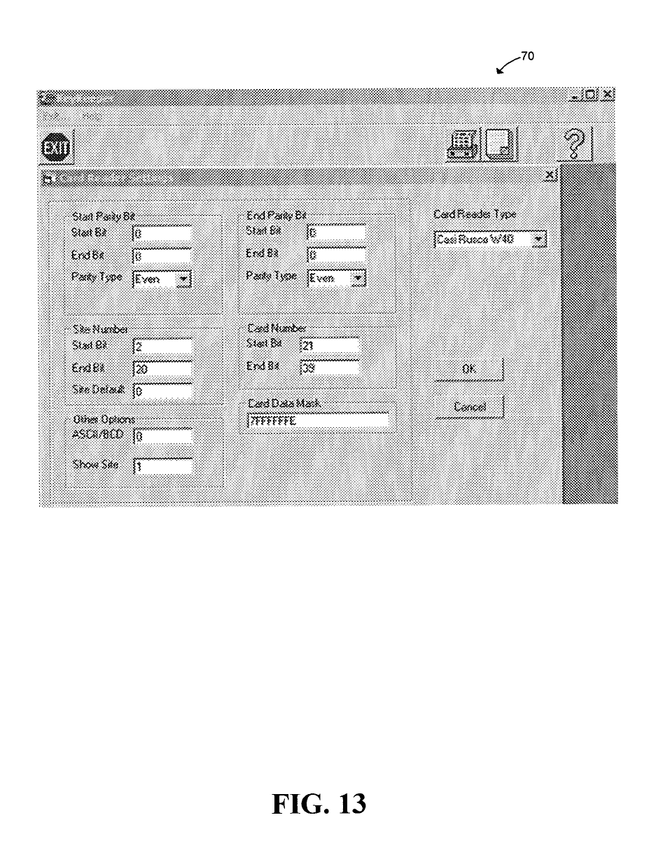

Another portion of the operation of the asset management system 30 in accordance with another embodiment of the present invention will now be described with reference to FIG. 13. By way of example only, the administrator at the remote system 40 may desire configuring one of the security asset managers, such as security asset manager 32(1), to use an access card reader coupled to the security asset manager 32(1) instead of or in addition to the keypad user input interface. Thus, instead of the user inputting a user ID using the keypad interface of the security asset manager 32(1) as described above connection with at step 302 in another embodiment, the user simply swipes their access card in the card reader interface. The card reader interface receives the Wiegand binary string stored in the swiped access card and transmits the string to the web server 36 in the security asset manager 32(1), although other types of access cards having different string formats may be used. The web server 36 decodes the user ID included in the Wiegand binary string, although the web server 36 may be configured to decode different types of strings where different types of access cards are used and customized Wiegand binary string formats.

Referring to FIG. 13, an access card reader configuration page 70 is shown. An administrator at the remote system 40 can input data in the fields of the access card reader configuration page 70 to configure the web server 36 to be able to decode one or more customized Wiegand binary string formats. The administrator at the remote system 40 may select the desired card reader used by the security asset manager 32(1) from a “Card Reader Type” pull down window on the page 70, although other selection means may be used. Once a particular card reader type is selected, such as “Casi Rusco W40,” the remainder of the fields in the access card reader configuration page 70 are automatically populated by values stored in the memory of the web server 36 which define the particular format of the string for the selected card reader, such as the locations within the string stored the card readable by the reader where the parity bits, site number bits and card number bits are located. Further, the access card reader configuration page 70 shows a “Card Data Mask” value that represents the card bit string definition values in hexadecimal format. By enabling the web server 36 to store different card reader profiles, there is no need for using hardware that converts the bit strings stored on access cards in customized formats.

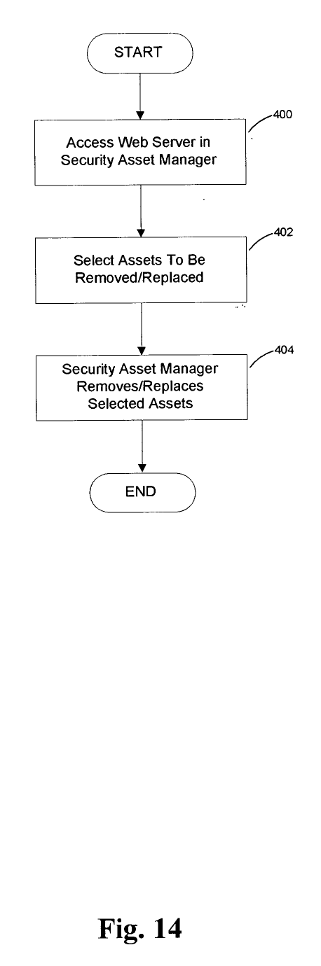

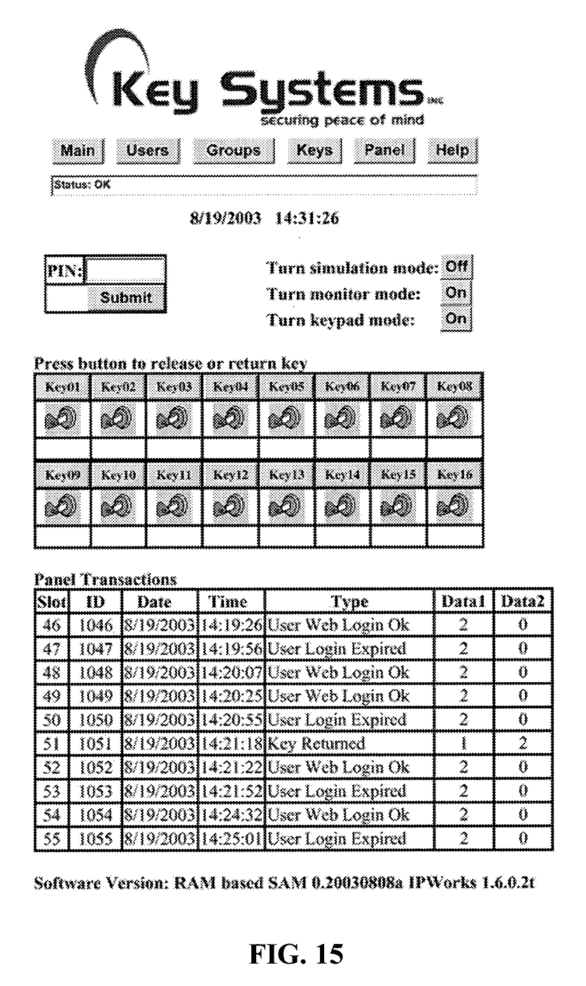

Another portion of the operation of the asset management system 30 in accordance with another embodiment of the present invention will now be described with reference to FIGS. 14-15. By way of example only, a user at the remote system 40 may desire controlling one of the security asset managers, such as security asset manager 32(1), to cause the security asset manager 32(1) to release or accept one or more of the assets, such as keys in this example. At step 400, a user at the remote system 40 accesses the web server 36 to receive a first Web page stored in the server 36 as described above in connection with step 100. The user selects the appropriate icons or other triggers in the page to initiate controlling the security asset manager 32(1). In response, the web server 36 sends a user control page 80 to the remote system 40 for the user to be able to select key icons for removing or replacing assets from the security asset manager 32(1) as shown in FIG. 15.

At step 402, the user at the remote system 40 selects one of the asset buttons Tabled “Key01” through “Key16” to release or return a key corresponding to the station in the security asset manager 32(1). In this example, the security asset manager 32(1) comprises sixteen stations for holding sixteen keys, although the manager 32(1) may include a fewer or greater number of stations. The user control page 80 illustrates each of the asset buttons “Key01” through “Key16” as being associated with an asset icon depicting a key being inserted into a corresponding key cylinder (not illustrated) in the security asset manager 32(1). This represents the key being present in the particular station at the particular location indicated by the asset button label (e.g., “Key01”). When a key not present in a corresponding station in the security asset manager 32(1), the asset icon illustrates an empty cylinder without a key (not illustrated). In this example, each of the assets icons associated with the asset buttons labled “Key01” through “Key16” show that a key is present in the corresponding key cylinders. In this example, the user at the remote system 40 selects removing the key from the security asset manager 32(1) corresponding to the asset button labled as “Key01”.

At step 404, the remote system 40 transmits the asset button selection information through the user control page 80 to the web server 36 in the security asset manager 32(1) along with a PIN code in the “PIN” field in page 80. When the web server 36 in the security asset manager 32(1) receives the asset button selection information along with a request to remove the key from the appropriate station in the security asset manager 32(1) and a valid PIN code, the web server 36 instructs a mechanism coupled to the station in the security asset manager 32(1) to release the asset (e.g., key) from the appropriate station. When the mechanism releases the key, a sensor (not illustrated) in the security asset manager 32(1) instructs the web server 36 that the station has released the asset. In response, the web server 36 refreshes the user control page 80 to show the asset icon associated with the asset button labled “Key01” without having a key inserted in the cylinder. This way, users at remote system 40 can directly access one or more of the security asset managers 32(1)-32(n) in the system 30 and individually control the security asset managers 32(1)-32(n). Furthermore, the users may individually control one or more of the stations in one or more of the security asset managers 32(1)-32(n) for receiving and releasing assets.

To replace the asset in the station of the security asset manager 32(1) that corresponds to the asset button labled “Key01”, for example, the user may again select the “Key01” button along with a PIN code in the “PIN” field in page 80. When the web server 36 in the security asset manager 32(1) receives the asset button selection information along with a request to replace the key to the appropriate station in the security asset manager 32(1) and a valid PIN code, the web server 36 instructs a mechanism coupled to the station in the security asset manager 32(1) to accept the asset (e.g., key) in the appropriate station when received. A user may then insert the asset in the appropriate station in the security asset manager 32(1). Once the key is received by the appropriate station in the security asset manager 32(1), a sensor (not illustrated) in the security asset manager 32(1) instructs the web server 36 that the station has received the asset. In response, the web server 36 refreshes the user control page 80 to show the asset icon associated with the asset button labled “Key01” with a key inserted in the cylinder. Again, users at remote system 40 can directly access one or more of the security asset managers 32(1)-32(n) in the system 30 and individually control the security asset managers 32(1)-32(n).

With the present invention, each of the security asset managers 32(1)-32(n) can be configured to meet customer needs using a remote system 40 without requiring system administrators to be physically near the security asset managers 32(1)-32(n). Control can be maintained over users by requiring pin numbers for specific access, dated and timed return and alarms for failure to comply. By providing each of the security asset managers 32(1)-32(n) with direct access to the network, there can be thousands of users/PIN codes. The security asset managers 32(1)-32(n) protect assets from unauthorized use, audit assets' presence, control assets' environment and provide audit trails of individual assets' use. Each of the security asset managers 32(1)-32(n) can stand alone releasing only assets authorized to a named person or group. Also, each of the security asset managers 32(1)-32(n) can hold almost any size or shape device, such as keys, computers, cell phones, utensils, money, computers, tools, doorways and medicine. Further, each of the security asset managers 32(1)-32(n) may have backup power supplies and are designed to provide fast and easy access to authorized users.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Further, the recited order of elements, steps or sequences, or the use of numbers, letters, or other designations therefor, is not intended to limit the claimed processes to any order except as may be explicitly specified in the claims. Accordingly, the invention is limited only by the following claims and equivalents thereto.

What is claimed is:

1. An asset management system comprising one or more stations for receiving a tangible asset and a server system coupled to a communication medium, wherein the server system stores information regarding tangible asset transactions between the stations and the tangible assets in the asset management system and allows the asset management system to be accessed remotely via the communication medium.

2. The system as set forth in claim 1 wherein the server system permits the asset management system to be accessed based on one or more criteria.

3. The system as set forth in claim 2 wherein the server system permits the tangible assets to be removed from the stations or replaced to the stations based on the one or more criteria.

4. The system as set forth in claim 2 further comprising a remote system that provides the one or more criteria to the server system.

5. The system as set forth in claim 2 wherein the one or more criteria comprises a user ID, a user password, and a user security access level.

6. The system as set forth in claim 1 wherein the server system provides a remote system with the stored information regarding the transactions with the stations.

7. The system as set forth in claim 1 wherein the server system stores information describing the asset management system, the information comprising at least one of an identity, a location and an installation date of the asset management system.

8. The system as set forth in claim 1 wherein the stored transaction information comprises at least one of a location of one or more of the stations where one or more of the tangible assets were removed from or replaced to, an identity of the stations where the tangible assets were removed from or replaced to, a date or time the tangible assets were removed, an identifier for each of the removed the tangible assets, and an identity of one or more users that removed the tangible assets.

9. The system as set forth in claim 1 wherein the server system stores alarm information describing one or more alarm conditions to be satisfied to trigger an alarm of the asset management system.

10. The system as set forth in claim 9 wherein the server system sounds the alarm of at least one of the asset management system and a remote system upon determining that the one or more alarm conditions have been satisfied.

11. The system as set forth in claim 1 wherein the server system provides a remote system with one or more graphical user interfaces for accepting data used by the server system to perform at least one of permitting the asset management system to be accessed, permitting the tangible assets to be removed from the stations, permitting the tangible assets to be replaced to the stations, setting alarm conditions, and storing information that describes the asset management system.

12. The system as set forth in claim 1 further comprising a user input interface that receives user identification information associated with a request to access the asset management system.

13. The system as set forth in claim 12 wherein the user input interface further comprises an access control card reader, the requester identification information being stored on an access card that is coupled to the access control card reader.

14. The system as set forth in claim 13 wherein the server system converts the requestor identification information from a first format to a second format.

15. A method for managing assets comprising:
providing an asset management system with one or more stations for receiving a tangible asset and a server system coupled to a communication medium;
storing information regarding tangible asset transactions between the stations and the tangible assets; and
allowing the asset management system to be accessed remotely via the communication medium.

16. The method as set forth in claim 15 further comprising permitting the asset management system to be accessed based on one or more criteria.

17. The method as set forth in claim 16 wherein the permitting the asset management system to be accessed further comprises permitting the tangible assets to be removed from the stations or replaced to the stations based on the one or more criteria.

18. The method as set forth in claim 16 further comprising providing the one or more criteria to the server system using a remote system.

19. The method as set forth in claim 16 wherein the one or more criteria comprises a user ID, a user password, and a user security access level.

20. The method as set forth in claim 15 further comprising providing a remote system with the stored information regarding the transactions with the stations using the server system.

21. The method as set forth in claim 15 further comprising storing information describing the asset management system, the information comprising at least one of an identity, a location and an installation date of the asset management system.

22. The method as set forth in claim 15 wherein the stored transaction information comprises at least one of a location of one or more of the stations where one or more of the tangible assets were removed from or replaced to, an identity of the stations where the tangible assets were removed from or replaced to, a date or time the tangible assets were removed, an identifier for each of the removed the tangible assets, and an identity of one or more users that removed the tangible assets.

23. The method as set forth in claim 15 further comprising storing alarm information describing one or more alarm conditions to be satisfied to trigger an alarm of the asset management system.

24. The method as set forth in claim 23 further comprising sounding the alarm of at least one of the asset management system and a remote system upon determining that the one or more alarm conditions have been satisfied.

25. The method as set forth in claim 15 further comprising using the server system to provide a remote system with one or more graphical user interfaces for accepting data used by the server system to perform at least one of permitting the asset management system to be accessed, permitting the tangible assets to be removed from the stations, permitting the tangible assets to be replaced to the stations, setting alarm conditions, and storing information that describes the asset management system.

26. The method as set forth in claim 15 further comprising receiving user identification information associated with a request to access the asset management system through a user input interface.

27. The method as set forth in claim 26 wherein the user input interface further comprises an access control card reader, the requestor identification information being stored on an access card that is coupled to the access control card reader.

28. The method as set forth in claim 27 wherein the server system converts the requester identification information from a first format to a second format.

29. A computer-readable medium having stored thereon instructions for managing assets, which when executed by at least one processor, causes the processor to perform:
providing an asset management system with one or more stations for receiving a tangible asset and a server system coupled to a communication medium;
storing information regarding tangible asset transactions between the stations and the tangible assets; and
allowing the asset management system to be accessed remotely via the communication medium.

30. The medium as set forth in claim 29 further comprising permitting the asset management system to be accessed based on one or more criteria.

31. The medium as set forth in claim 30 wherein the permitting the asset management system to be accessed further comprises permitting the tangible assets to be removed from the stations or replaced to the stations based on the one or more criteria.

32. The medium as set forth in claim 30 further comprising providing the one or more criteria to the server system using a remote system.

33. The medium as set forth in claim 30 wherein the one or more criteria comprises a user ID, a user password, and a user security access level.

34. The medium as set forth in claim 29 further comprising providing a remote system with the stored information regarding the transactions with the stations using the server system.

35. The medium as set forth in claim 29 further comprising storing information describing the asset management system, the information comprising at least one of an identity, a location and an installation date of the asset management system.

36. The medium as set forth in claim 29 wherein the stored transaction information comprises at least one of a location of one or more of the stations where one or more of the tangible assets were removed from or replaced to, an identity of the stations where the tangible assets were removed from or replaced to, a date or time the tangible assets were removed, an identifier for each of the removed the tangible assets, and an identity of one or more users that removed the tangible assets.

37. The medium as set forth in claim 29 further comprising storing alarm information describing one or more alarm conditions to be satisfied to trigger an alarm of the asset management system.

38. The medium as set forth in claim 37 further comprising sounding the alarm of at least one of the asset management system and a remote system upon determining that the one or more alarm conditions have been satisfied.

39. The medium as set forth in claim 29 further comprising using the server system to provide a remote system with one or more graphical user interfaces for accepting data used by the server system to perform at least one of permitting the asset management system to be accessed, permitting the tangible assets to be removed from the stations, permitting the tangible assets to be replaced to the stations, setting alarm conditions, and storing information that describes the asset management system.

40. The medium as set forth in claim 29 further comprising receiving user identification information associated with a request to access the asset management system through a user input interface.

41. The medium as set forth in claim 40 wherein the user input interface further comprises an access control card reader, the requestor identification information being stored on an access card that is coupled to the access control card reader.

42. The medium as set forth in claim 41 wherein the server system converts the requestor identification information from a first format to a second format.
